(19) United States
(12) Patent Application Publication
(10) Pub. No.: US 2017/0033951 A1
(43) Pub. Date: Feb. 2, 2017

(54) Method, Apparatus, and Communications System for Reciprocity Calibration Between UEs

(71) Applicant: Huawei Technologies Co., Ltd., Shenzhen (CN)

(72) Inventors: Lei Zhang, Shenzhen (CN); Lu Rong, Shanghai (CN)

(21) Appl. No.: 15/267,690

(22) Filed: Sep. 16, 2016

Related U.S. Application Data
(63) Continuation of application No. PCT/CN2014/073575, filed on Mar. 18, 2014.

(51) Int. Cl. H04L 25/02; H04B 17/14; H04B 17/21; H04L 5/00

(52) U.S. Cl. CPC H04L 25/0224; H04L 5/0048; H04B 17/14; H04B 17/21; H04L 25/0242

(57) ABSTRACT

An embodiment discloses a method, an apparatus, and a communications system for reciprocity calibration between UEs. The method includes sending, by a communication device, a first reference signal to a first user equipment UE, so that the first UE estimates first channel information of a first channel between the first UE and the communication device according to the first reference signal and receiving the first channel information fed back by the first UE; receiving a second reference signal sent by the first UE. The method also includes estimating second channel information of a second channel between the communication device and the first UE according to the second reference signal, and performing reciprocity calibration according to the first channel information and the second channel information.

### CROSS-REFERENCE TO RELATED APPLICATIONS

This application is a continuation of International Application No. PCT/CN2014/073575, filed on Mar. 18, 2014, which is hereby incorporated by reference in its entirety.

### TECHNICAL FIELD

The present invention relates to the communications field, and in particular, to a method, an apparatus, and a communications system of reciprocity calibration between UEs.

### BACKGROUND

Currently, channel reciprocity of a Long Term Evolution (LTE) Time Division Duplexing (TDD) system is better than that of a Frequency Division Duplex (FDD) system, and in a TDD system, an uplink channel and a downlink channel use a same frequency band. Therefore, in the TDD system, the downlink channel can be estimated according to the uplink channel, so as to improve transmission performance of the downlink channel, so that the TDD system is widely applied. However, in an actual TDD system, antennas of a base station and a user end each have an independent receive link and transmit link, and channel reciprocity is applicable only to a space propagation channel. Therefore, absolute channel reciprocity does not exist in the actual TDD system. In addition, a slight reciprocity error of uplink and downlink channels may cause an apparent change in performance of a communications system. Therefore, reciprocity calibration needs to be performed on an antenna before a characteristic of TDD channel reciprocity is used.

However, when performing reciprocity calibration on the antenna, it is found that, in the prior art, a reciprocity error of an antenna on a base station side can be generally resolved by using self-calibration of the antenna of the base station. Currently, however, a reciprocity error problem of an antenna between user equipments (UEs) on a UE side does not draw enough attention due to a limitation on an application scenario, and therefore is not effectively resolved yet.

### SUMMARY

Embodiments provide a method, an apparatus of reciprocity calibration between UEs, and a communications system, which can calibrate an reciprocity error between user equipments (UEs), thereby ensuring performance of the communications system.

To achieve the foregoing objective, the following technical solutions are provided in the embodiments.

According to a first aspect, a method for reciprocity calibration between UEs is provided, including sending, by a communication device, a first reference signal to a first UE, so that the first UE estimates first channel information of a first channel between the first UE and the communication device according to the first reference signal and receiving the first channel information fed back by the first UE. The method also includes receiving a second reference signal sent by the first UE and estimating second channel information of a second channel between the communication device and the first UE according to the second reference signal. Additionally, the method includes performing reciprocity calibration according to the first channel information and the second channel information.

In a first possible implementation manner of the first aspect, when the communication device is a second UE, before the sending, by a communication device, a first reference signal to a first UE, the method further includes sending, by the second UE, a first calibration request to a base station, so that the base station sends scheduling information to the second UE and the first UE according to the first calibration request, where the scheduling information includes an identifier of the first UE, an identifier of the second UE, and a time-frequency resource.

In a second possible implementation manner of the first aspect, when the communication device is a base station, before the sending, by a communication device, a first reference signal to a first UE, the method further includes receiving, by the base station, a second calibration request sent by the first UE, and sending scheduling information to the first UE according to the second calibration request, where the scheduling information includes an identifier of the first UE and a time-frequency resource.

With reference to the first aspect, the first possible implementation manner of the first aspect, or the second possible implementation manner of the first aspect, in a third possible implementation manner of the first aspect, the performing reciprocity calibration according to the first channel information and the second channel information specifically includes adjusting a reciprocity coefficient, so that a first channel matrix corresponding to the first channel information is equal to a second channel matrix corresponding to the second channel information.

According to a second aspect, a method for reciprocity calibration between UEs is provided, including receiving, by a first UE, a first reference signal sent by a communication device, and estimating first channel information of a first channel between the first UE and the communication device according to the first reference signal and sending the first channel information to the communication device. The method also includes sending a second reference signal to the communication device, so that the communication device estimates second channel information of a second channel between the communication device and the first UE according to the second reference signal, and performs reciprocity calibration according to the first channel information and the second channel information.

In a first possible implementation manner of the second aspect, when the communication device is a second UE, before the receiving, by a first UE, a first reference signal sent by a communication device, the method further includes receiving scheduling information that is sent by a base station according to a first calibration request, where the scheduling information includes an identifier of the first UE, an identifier of the second UE, and a time-frequency resource.

In a second possible implementation manner of the second aspect, when the communication device is a base station, before the receiving, by a first UE, a first reference signal sent by a communication device, the method further includes: sending a second calibration request to the base station; and receiving scheduling information that is sent by the base station according to the second calibration request, where the scheduling information includes an identifier of the first UE and a time-frequency resource.

According to a third aspect, a communication device is provided, including: a first sending unit, configured to send a first reference signal to a first UE, so that the first UE estimates first channel information of a first channel between the first UE and the communication device according to the first reference signal; a first receiving unit, configured to receive the first channel information fed back by the first UE; a second receiving unit, configured to receive a second reference signal sent by the first UE; an estimating unit, configured to estimate second channel information of a second channel between the communication device and the first UE according to the second reference signal received by the second receiving unit; and a calibration unit, configured to perform reciprocity calibration according to the first channel information received by the first receiving unit and the second channel information estimated by the estimating unit.

In a first possible implementation manner of the third aspect, when the communication device is a second UE, the communication device further includes: a second sending unit, configured to send a first calibration request to a base station, so that the base station sends scheduling information to the second UE and the first UE according to the first calibration request, where the scheduling information includes an identifier of the first UE, an identifier of the second UE, and a time-frequency resource.

In a second possible implementation manner of the third aspect, when the communication device is a base station, the communication device further includes: a third receiving unit, configured to receive a second calibration request sent by the first UE; and a second sending unit, configured to send scheduling information to the first UE according to the second calibration request received by the third receiving unit, where the scheduling information includes an identifier of the first UE and a time-frequency resource.

With reference to the third aspect, the first possible implementation manner of the third aspect, or the second possible implementation manner of the third aspect, in a third possible implementation manner of the third aspect, the calibration unit is specifically configured to adjust a reciprocity coefficient, so that a first channel matrix corresponding to the first channel information is equal to a second channel matrix corresponding to the second channel information.

According to a fourth aspect, a first UE is provided, including: a first receiving unit, configured to receive a first reference signal sent by a communication device, where first channel information of a first channel between the first UE and the communication device is estimated according to the first reference signal; a first sending unit, configured to send the first channel information to the communication device; and a second sending unit, configured to send a second reference signal to the communication device, so that the communication device estimates second channel information of a second channel between the communication device and the first UE according to the second reference signal, and performs reciprocity calibration according to the first channel information and the second channel information.

In a first possible implementation manner of the fourth aspect, when the communication device is a second UE, the first UE further includes a second receiving unit, configured to receive scheduling information that is sent by a base station according to a first calibration request, where the scheduling information includes an identifier of the first UE, an identifier of the second UE, and a time-frequency resource.

In a second possible implementation manner of the fourth aspect, when the communication device is a base station, the first UE further includes: a third sending unit, configured to send a second calibration request to the base station; and a second receiving unit, configured to receive scheduling information that is sent by the base station according to the second calibration request, where the scheduling information includes an identifier of the first UE and a time-frequency resource.

According to a fifth aspect, a communication device is provided, including: a communication unit, configured to communicate with an external device; a transmitter, configured to send a first reference signal to a first UE by using the communication unit, so that the first UE estimates first channel information of a first channel between the first UE and the communication device according to the first reference signal; a receiver, configured to receive, by using the communication unit, the first channel information fed back by the first UE, where the receiver is further configured to receive, by using the communication unit, a second reference signal sent by the first UE; and a processor, configured to estimate second channel information of a second channel between the communication device and the first UE according to the second reference signal, where the processor is further configured to perform reciprocity calibration according to the first channel information and the second channel information.

In a first possible implementation manner of the fifth aspect, when the communication device is a second UE, the transmitter is further configured to send a first calibration request to a base station by using the communication unit, so that the base station sends scheduling information to the second UE and the first UE according to the first calibration request, where the scheduling information includes an identifier of the first UE, an identifier of the second UE, and a time-frequency resource.

In a second possible implementation manner of the fifth aspect, when the communication device is a base station, the receiver is further configured to receive, by using the communication unit, a second calibration request sent by the first UE, and scheduling information is sent to the first UE according to the second calibration request, where the scheduling information includes an identifier of the first UE and a time-frequency resource.

With reference to the fifth aspect, the first possible implementation manner of the fifth aspect, or the second possible implementation manner of the fifth aspect, in a third possible implementation manner of the fifth aspect, that the processor performs reciprocity calibration according to the first channel information and the second channel information is specifically configured to adjust a reciprocity coefficient, so that a first channel matrix corresponding to the first channel information is equal to a second channel matrix corresponding to the second channel information.

According to a sixth aspect, a first UE is provided, including: a communication unit, configured to communicate with an external device; a receiver, configured to receive, by using the communication unit, a first reference signal sent by a communication device, where first channel information of a first channel between the first UE and the communication device is estimated according to the first reference signal; and a transmitter, configured to send the first channel information to the communication device by using the communication unit, where the transmitter is further configured to send a second reference signal to the communication device by using the communication unit, so that the communication device estimates second channel information of a second channel between the communication device and the first UE according to the second reference signal, and performs reciprocity calibration according to the first channel information and the second channel information.

In a first possible implementation manner of the sixth aspect, when the communication device is a second UE, the receiver is further configured to receive, by using the communication unit, scheduling information that is sent by a base station according to a first calibration request, where the scheduling information includes an identifier of the first UE, an identifier of the second UE, and a time-frequency resource.

In a second possible implementation manner of the sixth aspect, when the communication device is a base station, the transmitter is further configured to send a second calibration request to the base station by using the communication unit, and scheduling information that is sent by the base station according to the second calibration request is received, where the scheduling information includes an identifier of the first UE and a time-frequency resource.

According to a seventh aspect, a communications system is provided, including: a communication device and a first UE, where the communication device is the communication device corresponding to any one of the possible implementation manners of the third aspect, and the first UE is the first UE corresponding to any one of possible implementation manners of the fourth aspect; or the communication device is the communication device corresponding to any one of possible implementation manners of the fifth aspect, and the first UE is the first UE corresponding to any one of possible implementation manners of the sixth aspect.

According to the method for reciprocity calibration between UEs, the apparatus, and the communications system that are provided in the embodiments, a communication device receives first channel information that is of a first channel between a first UE and the communication device and is estimated by the first UE according to a first reference signal sent by the communication device, and second channel information that is of a second channel between the first UE and the communication device and is estimated according to a second reference signal reported by the first UE, so as to perform reciprocity error calibration between UEs according to the foregoing first channel information and the foregoing second channel information, thereby ensuring performance of the communications system.

### BRIEF DESCRIPTION OF THE DRAWINGS

To describe the technical solutions in the embodiments more clearly, the following briefly introduces the accompanying drawings required for describing the embodiments or the prior art. Apparently, the accompanying drawings in the following description show merely some embodiments, and persons of ordinary skill in the art may still derive other drawings from these accompanying drawings without creative efforts.

FIG. 1 is a schematic flowchart of an method for reciprocity calibration between UEs according to an embodiment;

FIG. 2 is a schematic flowchart of another method for reciprocity calibration between UEs according to an embodiment;

FIG. 3 is a schematic flowchart of still another method for reciprocity calibration between UEs according to an embodiment;

FIG. 4 is a schematic flowchart of yet another method for reciprocity calibration between UEs according to;

FIG. 5 is a schematic diagram of an apparatus of a communication device according to an embodiment;

FIG. 6 is a schematic diagram of an apparatus of another communication device according to an embodiment;

FIG. 7 is a schematic diagram of an apparatus of still another communication device according to an embodiment;

FIG. 8 is a schematic diagram of an apparatus of a first user equipment (UE) according to an embodiment;

FIG. 9 is a schematic diagram of an apparatus of another first UE according to an embodiment;

FIG. 10 is a schematic diagram of an apparatus of still another first UE according to an embodiment;

FIG. 11 is a schematic diagram of an apparatus of a communication device according to another embodiment;

FIG. 12 is a schematic diagram of an apparatus of a first UE according to another embodiment;

FIG. 13 is a system architecture diagram of a communications system according to an embodiment; and

FIG. 14 is a system architecture diagram of another communications system according to an embodiment.

### DETAILED DESCRIPTION OF ILLUSTRATIVE EMBODIMENTS

The following clearly and completely describes the technical solutions in the embodiments with reference to the accompanying drawings in the embodiments. Apparently, the described embodiments are merely some but not all of the embodiments. All other embodiments obtained by persons of ordinary skill in the art based on the embodiments without creative efforts shall fall within the protection scope of the embodiments.

The embodiments provided are applied to a Long Term Evolution (LTE) Time Division Duplexing (TDD) system. An uplink channel and a downlink channel of the foregoing TDD system use a same frequency band, and the downlink channel can be estimated according to the uplink channel, so as to improve downlink transmission performance. However, because absolute channel reciprocity does not exist in an actual TDD system, and a slight reciprocity error of uplink and downlink channels may cause an apparent change in system performance, an actual downlink channel cannot be reflected according to an uplink channel. Therefore, reciprocity calibration needs to be performed on an antenna before a characteristic of TDD channel reciprocity is used. Specifically, a main application scenario of embodiments is a cellular radio communications system, and a reciprocity error in the communications system is mainly includes two parts: a reciprocity error on a base station side and a reciprocity error on a user equipment (UE) side. For the reciprocity error on the base station side, a reciprocity error of the base station is generally resolved by using self-calibration of an antenna of the base station in the prior art, that is, a calibration antenna is selected from the antenna of the base station side, so as to calibrate another antenna of the base station by using the calibration antenna. However, a reciprocity error problem, between a receive channel and a transmit channel, on the UE side does not draw enough attention due to a limitation on an application scenario, so that there is no corresponding solution either. Therefore, based on the foregoing application scenario, the embodiments of embodiments provide a method for reciprocity calibration between UEs to resolve a reciprocity error problem between UEs.

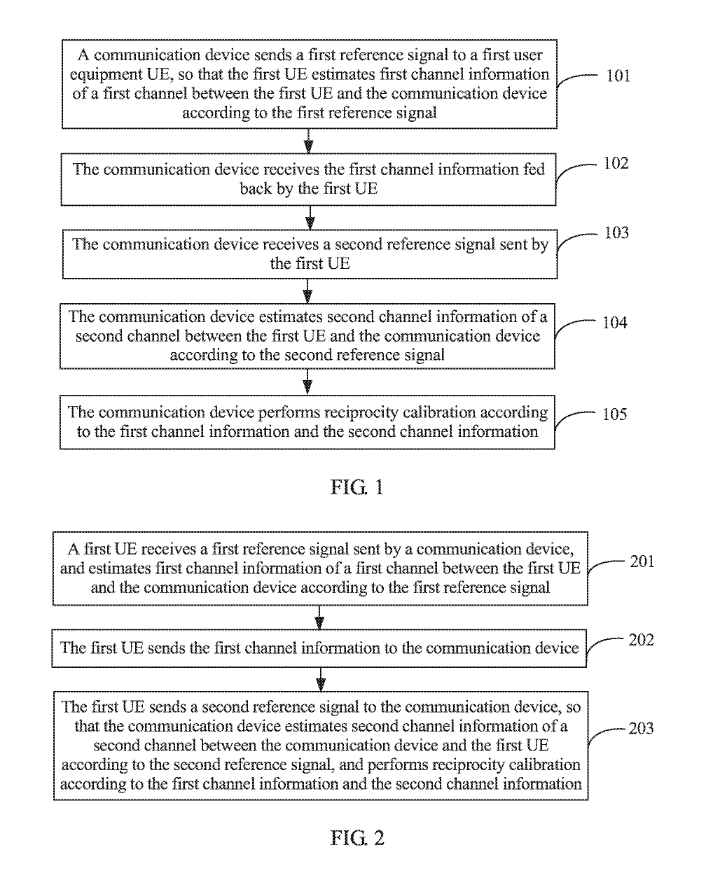

As shown in FIG. 1, an embodiment of the embodiments provides a method for reciprocity calibration method, where the method may be implemented by a communication device. The method for reciprocity calibration between UEs specifically includes the following steps.

101. The communication device sends a first reference signal to a first UE, so that the first UE estimates first channel information of a first channel between the first UE and the communication device according to the first reference signal.

Exemplarily, the foregoing communication device may be a base station, or may be a UE, and the foregoing first reference signal may be a signal known by the first UE, for example, pilot information. It should be noted that in this embodiment, the communication device can not only perform, with one first UE, reciprocity calibration between a single UE and the communication device, but also interact with multiple first UEs at the same time to implement reciprocity calibration between the multiple UEs.

102. The communication device receives the first channel information fed back by the first UE.

103. The communication device receives a second reference signal sent by the first UE.

The foregoing second reference signal may be a signal known by the communication device, for example, pilot information.

104. The communication device estimates second channel information of a second channel between the first UE and the communication device according to the second reference signal.

Specifically, when the foregoing communication device is a base station, the first channel, described in this embodiment, between the first UE and the communication device is a downlink between the base station and the first UE, and the second channel is an uplink between the first UE and the base station; when the foregoing communication device is a second UE, the first channel and the second channel, described in this embodiment, between the first UE and the communication device are receive and transmit channels between the first UE and the second UE.

105. The communication device performs reciprocity calibration according to the first channel information and the second channel information.

Optionally, step 105 may specifically include the following content.

105a. The communication device adjusts a first channel matrix corresponding to the first channel information and a second channel matrix corresponding to the second channel information, so that the first channel matrix is equal to the second channel matrix.

Exemplarily, the communication device calculates a reciprocity adjustment coefficient according to the acquired first channel information and second channel information between the first UE and the communication device, and sends the reciprocity adjustment coefficient to the first UE, so that the first UE adjusts, according to the reciprocity adjustment coefficient, the first channel matrix corresponding to the first channel information and the second channel matrix corresponding to the second channel information, and the foregoing first channel matrix is equal to the foregoing second channel matrix. The foregoing reciprocity adjustment coefficient is shown in Formula 1:

$$\frac{{α}_{1}^{r}}{{α}_{1}^{t}} = \frac{{α}_{2}^{r}}{{α}_{2}^{t}} = … = \frac{{α}_{N}^{r}}{{α}_{N}^{t}} = η . \qquad Formula 1$$

η is a nonzero constant. Coefficients of a radio-frequency receive channel (the foregoing first channel) of UE₁, UE₂, . . . , UE_{N} are respectively α₁^{r}, α₂^{r}, . . . , α_{N}^{r}, and coefficients of a radio-frequency transmit channel (the foregoing second channel) of the UE₁, UE₂, . . . , UE_{N} are respectively α₁^{t}, α₂^{t}, . . . , α_{N}^{t}. After the foregoing calibration process, a calibration result is that a first channel matrix of first channel information between each first UE and the communication device is equal to a second channel matrix of corresponding second channel information.

Exemplarily, an embodiment provides two methods of reciprocity calibration between UEs. A first implementation manner is: When the communication device is a second UE, the base station configures scheduling information for the first UE and the second UE, so that the first UE and the second UE directly perform reciprocity calibration between UEs according to the scheduling information. A second implementation manner is: when the communication device is the base station, the base station separately performs reciprocity calibration on at least two first UEs, so as to implement reciprocity calibration between UEs.

Optionally, when the communication device in an embodiment is a second UE (that is, in the first implementation manner), before step 101, the method further includes.

a1. The second UE sends a first calibration request to a base station, so that the base station sends scheduling information to the second UE and the first UE according to the first calibration request.

The foregoing scheduling information includes but is not limited to: an identifier of the first UE, an identifier of the second UE, and a time-frequency resource.

Optionally, when the communication device in an embodiment is a base station (that is, in the second implementation manner), before step 101, the method further includes.

a2. The base station receives a second calibration request sent by the first UE, and sends scheduling information to the first UE according to the second calibration request.

The foregoing scheduling information includes but is not limited to: an identifier of the first UE and a time-frequency resource.

Exemplarily, in a communications system described in an embodiment, each UE is allocated with a unique UE identifier, which is used to distinguish different UEs in the communications system (for example, used to distinguish the first UE and the second UE). In addition, the foregoing time-frequency resource is a specific time-frequency domain position of the first reference signal when the communication device sends the first reference signal to the first UE, and a specific time-frequency domain position of the second reference signal when the first UE sends the second reference signal to the communication device. Therefore, the first UE can accurately and effectively acquire the first reference signal sent by the communication device, and the communication device can accurately and effectively acquire the second reference signal sent by the first UE.

According to the method for reciprocity calibration between UEs provided in this embodiment, a communication device receives first channel information that is of a first channel between a first UE and the communication device and is estimated by the first UE according to a first reference signal sent by the communication device, and second channel information that is of a second channel between the first UE and the communication device and is estimated according to a second reference signal reported by the first UE, so as to perform reciprocity error calibration between UEs according to the foregoing first channel information and the foregoing second channel information, thereby ensuring performance of a communications system.

Corresponding to the method for reciprocity calibration between UEs shown in FIG. 1, the following describes, from a perspective of a first UE, a method for reciprocity calibration between UEs provided in an embodiment.

As shown in FIG. 2, an embodiment provides a method for reciprocity calibration between UEs, where the method may be implemented by a first UE, and the method for reciprocity calibration between UEs specifically includes the following steps.

201. The first UE receives a first reference signal sent by a communication device, and estimates first channel information of a first channel between the first UE and the communication device according to the first reference signal.

Exemplarily, the foregoing communication device may be a base station, or may be a UE. The foregoing first reference signal is a signal known by the first UE. It should be noted that in this embodiment, the communication device can not only perform, with one first UE, reciprocity calibration between a single UE and the communication device, but also interact with multiple first UEs at the same time to implement reciprocity calibration between the multiple UEs.

202. The first UE sends the first channel information to the communication device.

203. The first UE sends a second reference signal to the communication device, so that the communication device estimates second channel information of a second channel between the communication device and the first UE according to the second reference signal, and performs reciprocity calibration according to the first channel information and the second channel information.

Exemplarily, after receiving a reciprocity adjustment coefficient calculated by the communication device according to the acquired first channel information and second channel information between the first UE and the communication device, the first UE adjusts, according to the reciprocity adjustment coefficient, a first channel matrix corresponding to the first channel information and a second channel matrix corresponding to the second channel information, so that the foregoing first channel matrix is equal to the foregoing second channel matrix. The foregoing reciprocity adjustment coefficient is shown in Formula 2:

$$\frac{{α}_{1}^{r}}{{α}_{1}^{t}} = \frac{{α}_{2}^{r}}{{α}_{2}^{t}} = … = \frac{{α}_{N}^{r}}{{α}_{N}^{t}} = η . \qquad Formula 2$$

η is a nonzero constant. Coefficients of a radio-frequency receive channel (the foregoing first channel) of UE₁, UE₂, . . . , UE_{N} are respectively α₁^{r}, α₂^{r}, . . . , α_{N}^{r}, and coefficients of a radio-frequency transmit channel (the foregoing second channel) of the UE₁, UE₂, . . . , UE_{N} are respectively α₁^{t}, α₂^{t}, . . . , α_{N}^{t}. After the foregoing calibration process, a calibration result is that a first channel matrix of first channel information between each first UE and the communication device is equal to a second channel matrix of corresponding second channel information.

Exemplarily, an embodiment provides two methods for reciprocity calibration between UEs. A first implementation manner is: When the communication device is a second UE, the base station configures scheduling information for the first UE and the second UE, so that the first UE and the second UE directly perform reciprocity calibration between UEs according to the scheduling information. A second implementation manner is: When the communication device is the base station, the base station separately performs reciprocity calibration on at least two first UEs, so as to implement reciprocity calibration between UEs.

Optionally, when the communication device in an embodiment is a second UE (that is, in the first implementation manner), before step 201, the method further includes.

b1. The first UE receives scheduling information sent by a base station according to a first calibration request sent by the second UE.

The foregoing scheduling information includes but is not limited to: an identifier of the first UE, an identifier of the second UE, and a time-frequency resource.

Optionally, when the communication device in an embodiment is a base station (that is, in the second implementation manner), before step 201, the method further includes.

b2. The first UE sends a second calibration request to the base station, so that the base station sends scheduling information to the first UE according to the second calibration request.

The foregoing scheduling information includes but is not limited to: an identifier of the first UE and a time-frequency resource.

Exemplarily, in a communications system described in an embodiment, each UE is allocated with a unique UE identifier, which is used to distinguish different UEs in the communications system (for example, used to distinguish the first UE and the second UE). In addition, the foregoing time-frequency resource is a specific time-frequency domain position of the first reference signal when the communication device sends the first reference signal to the first UE, and a specific time-frequency domain position of the second reference signal when the first UE sends the second reference signal to the communication device. Therefore, the first UE can accurately and effectively acquire the first reference signal sent by the communication device, and the communication device can accurately and effectively acquire the second reference signal sent by the first UE.

According to the method for reciprocity calibration between UEs provided in this embodiment, a first UE estimates first channel information of a first channel between the first UE and a communication device according to a first reference signal sent by the communication device, and feeds back the first channel information to a communication device, so that the communication device performs reciprocity error calibration between UEs according to the first channel information and second channel information that is of a second channel between the first UE and the communication device and is estimated according to a second reference signal reported by the first UE, thereby ensuring performance of a communications system.

The following exemplarily describes, in a specific application scenario, a method for reciprocity calibration between UEs provided in an embodiment. For descriptions about technical terms, concepts, and the like in the following embodiment that are related to the foregoing embodiments, reference may be made to the foregoing embodiments.

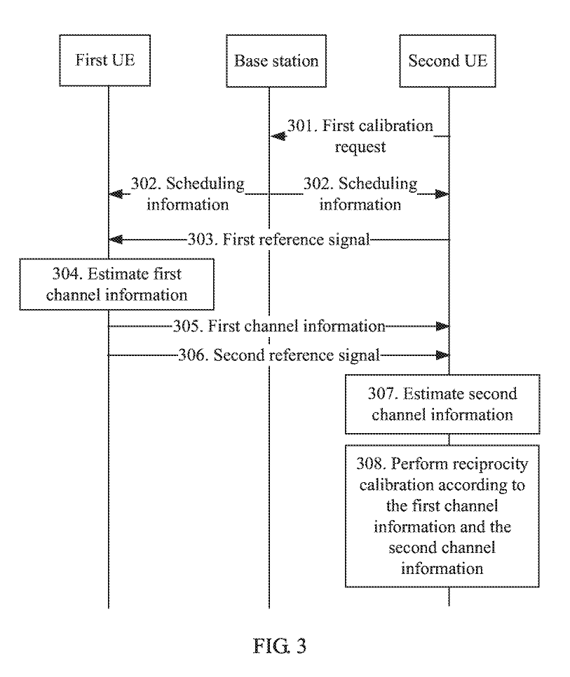

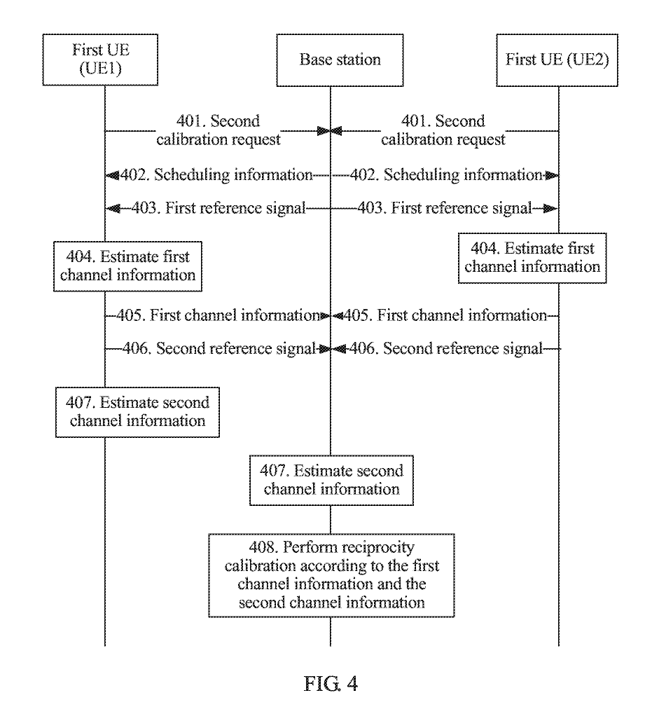

The following embodiments mainly focus on different processes for reciprocity calibration between UEs corresponding to different communication devices. Specifically, as shown in FIG. 3, when the communication device is a second UE, a corresponding reciprocity calibration method is a method for performing reciprocity calibration between UEs directly by a first UE and the second UE in a case in which a base station involves resource scheduling. As shown in FIG. 4, when the communication device is a base station, a corresponding reciprocity calibration method is a method for implementing reciprocity calibration between UEs by separately controlling at least two first UEs by the base station.

Specifically, for the corresponding method for reciprocity calibration between UEs, provided in an embodiment, when the communication device is a second UE, reference may be made to FIG. 3, as shown in FIG. 3.

301. The second UE sends a first calibration request to a base station.

302. The base station sends scheduling information to the communication device and a first UE according to the first calibration request.

Exemplarily, after the second UE sends the first calibration request to the base station, the base station sends the scheduling information to the second UE and at least one first UE according to the first calibration request, so that the second UE and each first UE fast and accurately acquire a first reference signal or a second reference signal according to the scheduling information. The foregoing scheduling information includes but is not limited to: an identifier of the first UE, an identifier of the second UE, and a time-frequency resource. Specifically, in a communications system described in an embodiment, each UE is allocated with a unique UE identifier, which is used to distinguish different UEs in the communications system (for example, used to distinguish the first UE and the second UE). In addition, the foregoing time-frequency resource is a specific time-frequency domain position of the first reference signal when the second UE sends the first reference signal to the first UE, and a specific time-frequency domain position of the second reference signal when the first UE sends the second reference signal to the second UE. Therefore, the first UE can accurately and effectively acquire the first reference signal sent by the second UE, and the second UE can accurately and effectively acquire the second reference signal sent by the first UE.

303. The second UE sends a first reference signal to the first UE.

The foregoing first reference signal is a signal known by the first UE.

Optionally, when the foregoing scheduling information further includes transmit power, step 303 specifically includes: the second UE can send the first reference signal to the first UE at the transmit power.

304. The first UE calculates first channel information of a first channel between the first UE and the second UE according to the first reference signal.

305. The second UE receives the first channel information fed back by the first UE.

306. The second UE receives a second reference signal reported by the first UE.

The foregoing second reference signal is a signal known by the second UE.

Optionally, when the foregoing scheduling information includes transmit power, step 306 specifically includes: the second UE receives the second reference signal that is reported by the first UE at the transmit power.

307. The second UE calculates second channel information of a second channel between the first UE and the second UE according to the second reference signal.

For the second UE, the first channel and the second channel between the foregoing first UE and the second UE are a transmit channel and a receive channel between the first UE and the second UE; however, for the first UE, the first channel and the second channel between the foregoing first UE and the second UE are a receive channel and a transmit channel between the first UE and the second UE.

308. The second UE performs reciprocity calibration according to the first channel information and the second channel information.

Optionally, step 308 specifically includes the following content: The second UE adjusts a first channel matrix corresponding to the first channel information and a second channel matrix corresponding to the second channel information, so that the first channel matrix is equal to the second channel matrix.

Exemplarily, the second UE calculates a reciprocity adjustment coefficient according to the acquired first channel information and second channel information between the first UE and the second UE, and sends the reciprocity adjustment coefficient to the first UE, so that the first UE adjusts, according to the reciprocity adjustment coefficient, the first channel matrix corresponding to the first channel information and the second channel matrix corresponding to the second channel information, and the foregoing first channel matrix is equal to the foregoing second channel matrix.

Exemplarily, in this embodiment, a UE1 is used as an example for the second UE, and a UE2 is used as an example for the first UE. In addition, in this embodiment, the base station allocates configuration information for calibration to the UE1 and the UE2 specifically by using downlink scheduling, where the scheduling information can be sent, by using a control channel or another channel, to all UEs involving calibration, or to some UEs, which then forward the scheduling information to other users. When the communications system includes only one first UE, that is, when the communications system includes the UE1 and the UE2, a process of reciprocity calibration between UEs provided in this embodiment is: First, the UE2 and the UE1 respectively estimate a first channel to obtain first channel information H1 and a second channel to obtain second channel information H2, as specifically shown in the following:

H₁=α₂^{t}·h₁·α₁^{r} Formula 3, and

H₂=α₁^{t}·h₁·α₂^{r} Formula 4.

The foregoing α₁^{r} is a receive channel parameter of the UE1, α₁^{t} is a transmit channel parameter, and h₁ is a space channel between the UE1 and the UE2. α₂^{r} is a receive channel parameter of the UE2, and α₂^{t} is a transmit channel parameter of the UE2. H1 is made equal to H2 by using coefficient compensation calibration, then:

$$\frac{{α}_{1}^{r}}{{α}_{1}^{t}} = \frac{{α}_{2}^{r}}{{α}_{2}^{t}} ,$$

so that receive and transmit channel matrices between the UE1 and the UE2 are equal, thereby implementing reciprocity calibration between two UEs. In addition, when the communication device includes multiple UEs, that is, there are more than two UEs, a second UE, that is the UE1, should be first selected from all UEs on a user side, and all other UEs (that are, the UE2, a UE3, . . . , and a UEn, where n is a natural number greater than or equal to two) each send a first reference signal to the UE1, the UE1 broadcasts a second reference signal to all the other UEs at the same time, and it is finally implemented that:

$$\frac{{α}_{1}^{r}}{{α}_{1}^{t}} = \frac{{α}_{2}^{r}}{{α}_{2}^{t}} = … = \frac{{α}_{N}^{r}}{{α}_{N}^{t}} = η ,$$

where η is a nonzero constant. After the foregoing calibration process, a calibration result is that a quotient of a receive and transmit channel coefficient of each UE is equal, that is, receive and transmit channel matrices of all the UEs are equal, thereby implementing reciprocity calibration between multiple UEs.

Exemplarily, in this embodiment, UEs send reference signals to each other to calculate a reciprocity parameter to complete calibration. In addition, because a distance between users is generally relatively short, accuracy of estimating the reference signals is relatively high. Therefore, accuracy of calibration is also relatively high.

It should be noted that, because a main application scenario of this embodiment is a cellular radio communications system, reciprocity calibration between UEs needs to be implemented on a cellular frequency band. In addition, in order not to interfere with normal communication between another UE and a base station, reciprocity calibration between the UEs needs to be performed under control of the base station, and reference signals between the UEs need to be sent at the same time as much as possible to ensure that a space signal is unchanged.

According to the method for reciprocity calibration between UEs provided in this embodiment, a second UE receives first channel information that is of a first channel between first UE and the second UE and is estimated by the first UE according to a first reference signal sent by the second UE, and second channel information that is of a second channel between the first UE and the second UE and is estimated according to a second reference signal reported by the first UE, so as to perform reciprocity error calibration between UEs according to the foregoing first channel information and the foregoing second channel information, thereby ensuring performance of a communications system.

Specifically, for the corresponding method for reciprocity calibration between UEs, provided in an embodiment, when the communication device is a base station, reference may be made to FIG. 4, as shown in FIG. 4.

401. A first UE sends a second calibration request to the base station.

402. The base station sends scheduling information to the first UE according to the second calibration request.

Exemplarily, in this embodiment, a communications system may include one first UE or may include multiple first UEs, and in an actual application, the communications system generally includes multiple first UEs, so as to perform reciprocity calibration between the multiple UEs. Specifically, after each first UE in at least one first UE sends a second calibration request to the base station, the base station sends scheduling information to each first UE according to the second calibration request, so that each first UE fast and accurately acquires a first reference signal according to the scheduling information. The foregoing scheduling information includes but is not limited to: an identifier of each first UE, and a time-frequency resource. Specifically, in the communications system described in an embodiment, each UE is allocated with a unique UE identifier, which is used to distinguish multiple different first UEs in the communications system. In addition, the foregoing time-frequency resource is a specific time-frequency domain position of the first reference signal when the communication device sends the first reference signal to the first UE, so that the first UE can accurately and effectively acquire the first reference signal sent by the base station, and the communication device can accurately and effectively acquire a second reference signal sent by the first UE.

403. The base station sends a first reference signal to the first UE.

The foregoing first reference signal is a signal known by the first UE.

404. The first UE estimates first channel information of a first channel between the first UE and the base station according to the first reference signal.

405. The base station receives the first channel information fed back by the first UE.

406. The base station receives a second reference signal reported by the first UE.

The foregoing second reference signal is a signal known by the base station.

Optionally, when the foregoing scheduling information may further specifically include transmit power, step 406 specifically includes: the base station receives the second reference signal that is reported by the first UE at the foregoing transmit power.

407. The base station estimates second channel information of a second channel between the first UE and the base station according to the second reference signal.

Specifically, the foregoing first channel between the first UE and the base station is a downlink between the base station and the first UE, and the foregoing second channel between the first UE and the base station is an uplink between the first UE and the base station.

408. The base station performs reciprocity calibration according to the first channel information and the second channel information.

Optionally, step 408 specifically includes the following content: The base station adjusts a first channel matrix corresponding to the first channel information and a second channel matrix corresponding to the second channel information, so that the first channel matrix is equal to the second channel matrix.

Exemplarily, the base station calculates a reciprocity adjustment coefficient according to the acquired first channel information and second channel information between the first UE and the base station, and sends the reciprocity adjustment coefficient to the first UE, so that the first UE adjusts, according to the reciprocity adjustment coefficient, the first channel matrix corresponding to the first channel information and the second channel matrix corresponding to the second channel information, and the foregoing first channel matrix is equal to the foregoing second channel matrix.

Exemplarily, in this embodiment, two first UEs (merely used as an example herein, but not limited to the two first UEs in a specific application) are used as an example for a user end. That is, a UE1 and a UE2 are used as an example. In addition, the base station in this embodiment allocates configuration information for calibration to the UE1 and the UE2 specifically by using downlink scheduling, where the scheduling information can be sent, by using a control channel or another channel, to all first UEs involving calibration, or to some first UEs, which then forward the scheduling information to another user. Specifically, a process of reciprocity calibration between UEs provided in this embodiment is: First, the UE1 and the UE2 separately send a second reference signal to the base station, and the base station separately estimates second channel information of second channels (that is, uplinks) of the UE1 and the UE2 according to the second reference signal, as specifically shown in the following:

H₁^{U}=α₁^{t}·h₁·β^{r} Formula 5, and

H₂^{U}=α₂^{t}·h₂·β^{r} Formula 6.

The foregoing α₁^{t} is a transmit channel coefficient of the UE1, the foregoing α₂^{t} is a transmit channel coefficient of the UE2, the foregoing h₁ is a space channel between the UE1 and the base station, the foregoing h₂ is a space channel between the UE2 and the base station, and β^{r} is a receive channel coefficient of a receiver of the base station. When the UE1 and the UE2 separately send the second reference signal to the base station, the base station sends the first reference signal to the UE1 and the UE2, and the UE1 and the UE2 separately estimate first channel information of first channels (downlinks) according to the first reference signal sent by the base station, as specifically shown in the following:

H₁^{D}=α₁^{r}·h₁·β^{t} Formula 5, and

H₂^{D}=α₂^{r}·h₂·β^{t} Formula 6.

The foregoing α₁^{r} is a receive channel coefficient of the UE1, the foregoing α₂^{r} is a receive channel coefficient of the UE2, and β^{t} is a transmit channel coefficient of the transmitter of the base station.

According to the foregoing Formula 5 to Formula 8, H₁^{U} is made equal to H₁^{D}, then, a reciprocity calibration coefficient of the UE1 is obtained:

$$A = \frac{{α}_{1}^{r}}{{α}_{1}^{t}} = \frac{{h}_{1} \cdot {β}^{r}}{{h}_{1} \cdot {β}^{t}} = \frac{{β}^{r}}{{β}^{t}} .$$

H^{U}₂ is made equal to H₂^{D}, then, a reciprocity calibration coefficient of the UE2 is obtained:

$$B = \frac{{α}_{2}^{r}}{{α}_{2}^{t}} = \frac{{h}_{2} \cdot {β}^{r}}{{h}_{2} \cdot {β}^{t}} = \frac{{β}^{r}}{{β}^{t}} .$$

A is made equal to B by using coefficient compensation calibration, then:

$$\frac{{α}_{1}^{r}}{{α}_{1}^{t}} = \frac{{α}_{2}^{r}}{{α}_{2}^{t}} ,$$

so that a first channel matrix and a second channel matrix between the UE1 and the base station are equal, and a first channel matrix and a second channel matrix between the UE2 and the base station are equal, thereby implementing reciprocity calibration between two UEs. In addition, when the foregoing process is implemented when there are more than two first UEs (that is, UE₃, UE₄, . . . , and UEn, where n is a natural number greater than or equal to three), it is finally implemented that:

$$\frac{{α}_{1}^{r}}{{α}_{1}^{t}} = \frac{{α}_{2}^{r}}{{α}_{2}^{t}} = … = \frac{{α}_{N}^{r}}{{α}_{N}^{t}} = η ,$$

where η is a nonzero constant. After the foregoing calibration process, a calibration result is that a channel matrix of a receive channel and a transmit channel of each first UE is equal, and a first channel matrix and a second channel matrix between each first UE and the base station are equal, thereby implementing reciprocity calibration between multiple UEs.

Exemplarily, in this embodiment, the base station separately controls at least two first UEs, so that a reciprocity parameter between UEs is calculated by fully using a resource preconfigured by the base station without additional resource scheduling.

It should be noted that, when the communications system includes only one first UE, the base station may be considered as the second UE in the embodiment corresponding to FIG. 3, and directly performs, with the first UE, reciprocity calibration between UEs during which the base station involves resource scheduling. In addition, because a main application scenario of this embodiment is a cellular radio communications system, reciprocity calibration between UEs needs to be implemented on a cellular frequency band, and in order not to interfere with normal communication between another UE and a base station, reciprocity calibration between the UEs needs to be performed under control of the base station, and reference signals between the UEs need to be sent at the same time as much as possible to ensure that a space signal is unchanged.

According to the method for reciprocity calibration between UEs provided in this embodiment, a base station receives first channel information that is of a first channel between a first UE and the base station and is estimated by the first UE according to a first reference signal sent by the base station, and second channel information that is of a second channel between the first UE and the base station and is estimated according to a second reference signal reported by the first UE, so as to perform reciprocity error calibration between UEs according to the foregoing first channel information and the foregoing second channel information, thereby ensuring performance of a communications system.

Embodiments further provide corresponding devices to implement the methods for reciprocity calibration between UEs provided in the embodiments.

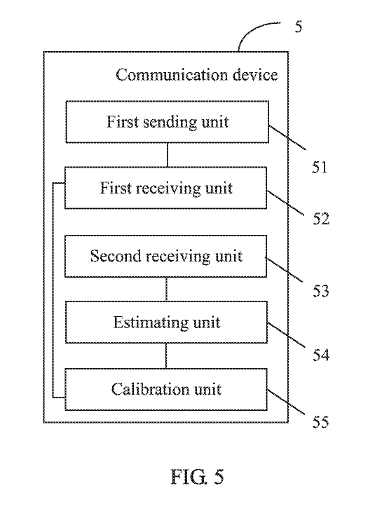

An embodiment provides a communication device, which can be configured to implement the communication device in the embodiments shown in FIG. 1 to FIG. 4. For content, such as functions, working mechanisms, related technical terms, and concepts of the communication device provided in this embodiment, reference may be made to the embodiments shown in FIG. 1 to FIG. 4. As shown in FIG. 5, a communication device 5 includes: a first sending unit 51, a first receiving unit 52, a second receiving unit 53, an estimating unit 54, and a calibration unit 55.

The first sending unit 51 is configured to send a first reference signal to a UE, so that the first UE estimates first channel information of a first channel between the first UE and the communication device according to the first reference signal.

The first receiving unit 52 is configured to receive the first channel information fed back by the first UE.

The second receiving unit 53 is configured to receive a second reference signal sent by the first UE.

The estimating unit 54 is configured to estimate second channel information of a second channel between the communication device and the first UE according to the second reference signal received by the second receiving unit 53.

The calibration unit 55 is configured to perform reciprocity calibration according to the first channel information received by the first receiving unit 52 and the second channel information estimated by the estimating unit 54.

According to the communication device provided in this embodiment, the communication device receives first channel information that is of a first channel between a first UE and the communication device and is estimated by the first UE according to a first reference signal sent by the communication device, and second channel information that is of a second channel between the first UE and the communication device and is estimated according to a second reference signal reported by the first UE, so as to perform reciprocity error calibration between UEs according to the foregoing first channel information and the foregoing second channel information, thereby ensuring performance of a communications system.

Optionally, as shown in FIG. 6, when the foregoing communication device is a second UE, the communication device 5 further includes: a second sending unit 56a.

The second sending unit 56a is configured to send a first calibration request to a base station, so that the base station sends scheduling information to the second UE and the first UE according to the first calibration request.

The foregoing scheduling information includes an identifier of the first UE, an identifier of the second UE, and a time-frequency resource.

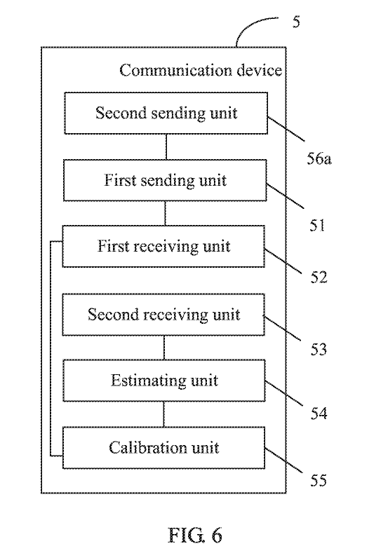

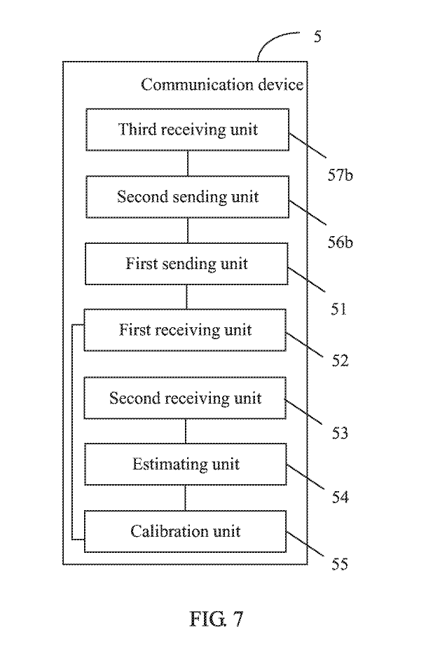

Optionally, as shown in FIG. 7, when the foregoing communication device is a base station, the communication device 5 further includes: a third receiving unit 57b and a second sending unit 56b.

The third receiving unit 57b is configured to receive a second calibration request sent by the first UE.

The second sending unit 56b is configured to send scheduling information to the first UE according to the second calibration request received by the third receiving unit 57b.

The foregoing scheduling information includes an identifier of the first UE and a time-frequency resource.

Optionally, the foregoing calibration unit 55 is specifically configured to adjust a reciprocity coefficient, so that a first channel matrix corresponding to the first channel information is equal to a second channel matrix corresponding to the second channel information.

According to the communication device provided in this embodiment, the communication device receives first channel information that is of a first channel between a first UE and the communication device and is estimated by the first UE according to a first reference signal sent by the communication device, and second channel information that is of a second channel between the first UE and the communication device and is estimated according to a second reference signal reported by the first UE, so as to perform reciprocity error calibration between UEs according to the foregoing first channel information and the foregoing second channel information, thereby ensuring performance of a communications system.

Unit division of the communication device in this embodiment is exemplary, and actually there may be multiple unit division methods to form the communication device in this embodiment.

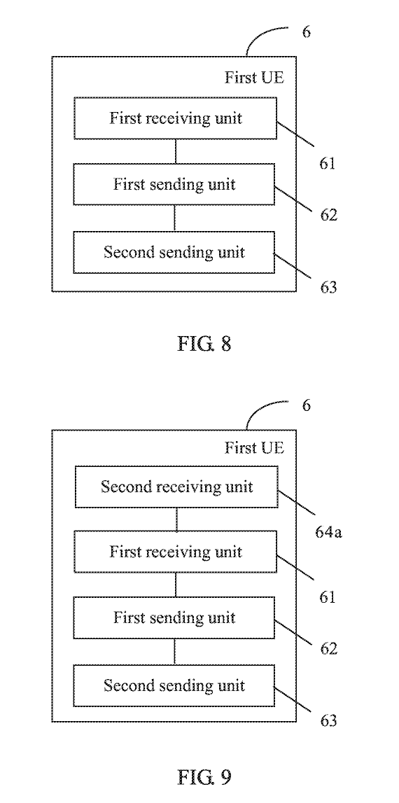

An embodiment provides a first UE, which can be configured to implement the first UE in the embodiments shown in FIG. 1 to FIG. 4. For content, such as functions, working mechanisms, related technical terms, and concepts of the first UE provided in this embodiment, reference may be made to the embodiments shown in FIG. 1 to FIG. 4. As shown in FIG. 8, a first UE 6 includes: a first receiving unit 61, a first sending unit 62, and a second sending unit 63.

The first receiving unit 61 is configured to receive a first reference signal sent by a communication device, where first channel information of a first channel between the first UE and the communication device is estimated according to the first reference signal.

The first sending unit 62 is configured to send the first channel information to the communication device.

The second sending unit 63 is configured to send a second reference signal to the communication device, so that the communication device estimates second channel information of a second channel between the communication device and the first UE according to the second reference signal, and performs reciprocity calibration according to the first channel information and the second channel information.

According to the first UE provided in this embodiment, the first UE estimates first channel information of a first channel between the first UE and a communication device according to a first reference signal sent by the communication device, and feeds back the first channel information to a communication device, so that the b communication device performs reciprocity error calibration between UEs according to the first channel information and second channel information that is of a second channel between the first UE and the communication device and is estimated according to a second reference signal reported by the first UE, thereby ensuring performance of a communications system.

Optionally, as shown in FIG. 9, when the communication device is a second UE, the first UE 6 further includes: a second receiving unit 64a.

The second receiving unit 64a is configured to receive scheduling information that is sent by a base station according to a first calibration request.

The foregoing scheduling information includes an identifier of the first UE, an identifier of the second UE, and a time-frequency resource.

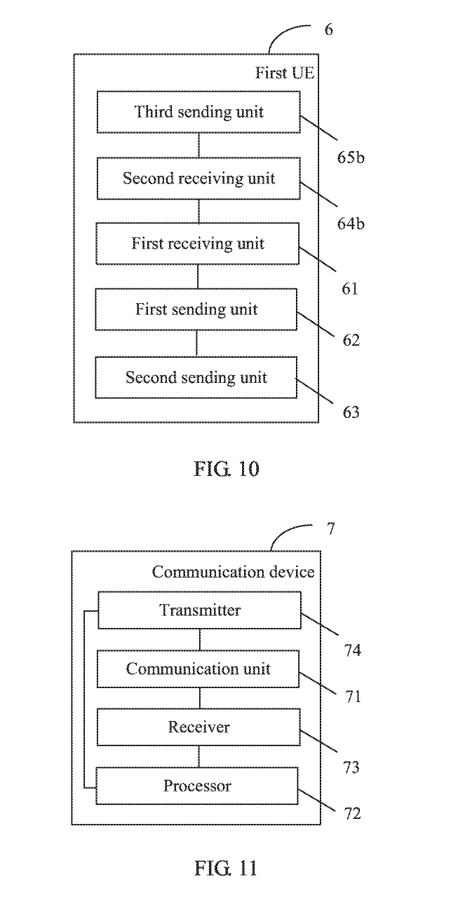

Optionally, as shown in FIG. 10, when the communication device is a base station, the first UE 6 further includes: a third sending unit 65b and a second receiving unit 64b.

The third sending unit 65b is configured to send a second calibration request to the base station.

The second receiving unit 64b is configured to receive scheduling information that is sent by the base station according to the second calibration request.

The foregoing scheduling information includes an identifier of the first UE and a time-frequency resource.

According to the first UE provided in this embodiment, the first UE estimates first channel information of a first channel between the first UE and a communication device according to a first reference signal sent by the communication device, and feeds back the first channel information to a communication device, so that the communication device performs reciprocity error calibration between UEs according to the first channel information and second channel information that is of a second channel between the first UE and the communication device and is estimated according to a second reference signal reported by the first UE, thereby ensuring performance of a communications system.

Unit division of the first UE in this embodiment is exemplary, and actually there may be multiple unit division methods to form the first UE in this embodiment.

The communication device provided in this embodiment may be a base station, or may be a UE. For content, such as specific working mechanisms, interworking with another network element, related technical terms, and concepts of the communication device, reference may be made to the communication device shown in the embodiments corresponding to FIG. 1 to FIG. 4, and details are not described herein again.

Exemplarily, as shown in FIG. 11, a communication device 7 includes a communication unit 71, a processor 72, a receiver 73, and a transmitter 74.

The communication unit 71 is configured to communicate with an external device.

The transmitter 74 is configured to send a first reference signal to a first UE by using the communication unit 71, so that the first UE estimates first channel information of a first channel between the first UE and the communication device according to the first reference signal.

The receiver 73 is configured to receive, by using the communication unit 71, the first channel information fed back by the first UE.

The receiver 73 is further configured to receive, by using the communication unit 71, a second reference signal sent by the first UE.

The processor 72 is configured to estimate second channel information of a second channel between the communication device and the first UE according to the second reference signal.

The processor 72 is configured to perform reciprocity calibration according to the first channel information and the second channel information.

Optionally, when the communication device is a second UE, the transmitter 74 is further configured to send a first calibration request to a base station by using the communication unit 71, so that the base station sends scheduling information to the second UE and the first UE according to the first calibration request. The foregoing scheduling information includes an identifier of the first UE, an identifier of the second UE, and a time-frequency resource.

Optionally, when the communication device is a base station, the receiver 73 is further configured to receive, by using the communication unit 71, a second calibration request sent by the first UE, and scheduling information is sent to the first UE according to the second calibration request. The foregoing scheduling information includes an identifier of the first UE and a time-frequency resource.

Optionally, that the processor 72 performs reciprocity calibration according to the first channel information and the second channel information is specifically configured to adjust a reciprocity coefficient, so that a first channel matrix corresponding to the first channel information is equal to a second channel matrix corresponding to the second channel information.

According to the communication device provided in this embodiment, the communication device receives first channel information that is of a first channel between a first UE and the communication device and is estimated by the first UE according to a first reference signal sent by the communication device, and second channel information that is of a second channel between the first UE and the communication device and is estimated according to a second reference signal reported by the first UE, so as to perform reciprocity error calibration between UEs according to the foregoing first channel information and the foregoing second channel information, thereby ensuring performance of a communications system.

Unit division of the communication device in this embodiment is exemplary, and actually there may be multiple unit division methods to form the communication device in this embodiment.

An embodiment provides a first UE. For content, such as specific working mechanisms, interworking with another network element, related technical terms, and concepts of the first UE, reference may be made to the first UE shown in the embodiments corresponding to FIG. 1 to FIG. 4, and details are not described herein again.

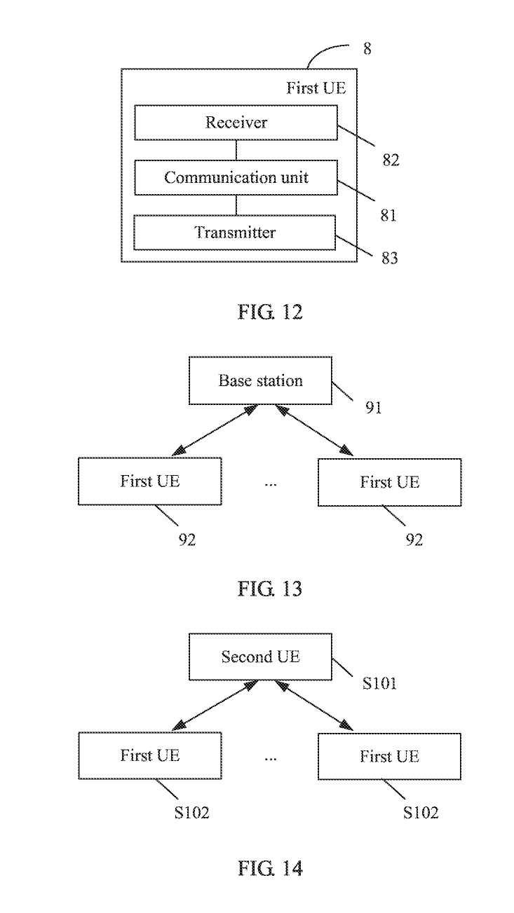

Exemplarily, as shown in FIG. 12, a first UE 8 includes a communication unit 81, a receiver 82, and a transmitter 83.

The communication unit 81 is configured to communicate with an external device.

The receiver 82 is configured to receive, by using the communication unit 81, a first reference signal sent by a communication device, where first channel information of a first channel between the first UE and the communication device is estimated according to the first reference signal.

The transmitter 83 is configured to send the first channel information to the communication device by using the communication unit 81.

The transmitter 83 is further configured to send a second reference signal to the communication device by using the communication unit 81, so that the communication device estimates second channel information of a second channel between the communication device and the first UE according to the second reference signal, and performs reciprocity calibration according to the first channel information and the second channel information.

Optionally, when the communication device is a second UE, the receiver 82 is further configured to receive, by using the communication unit 81, scheduling information that is sent by a base station according to a first calibration request. The foregoing scheduling information includes an identifier of the first UE, an identifier of the second UE, and a time-frequency resource.

Optionally, when the communication device is a base station, the transmitter 83 is further configured to send a second calibration request to the base station by using the communication unit 81, and scheduling information that is sent by the base station according to the second calibration request is received. The foregoing scheduling information includes an identifier of the first UE and a time-frequency resource.

According to the first UE provided in this embodiment, the first UE estimates first channel information of a first channel between the first UE and a communication device according to a first reference signal sent by the communication device, and feeds back the first channel information to a communication device, so that the communication device performs reciprocity error calibration between UEs according to the first channel information and second channel information that is of a second channel between the first UE and the communication device and is estimated according to a second reference signal reported by the first UE, thereby ensuring performance of a communications system.

Unit division of the first UE in this embodiment is exemplary, and actually there may be multiple unit division methods to form the first UE in this embodiment.

An embodiment provides a communications system, and when the communications system is a base station, as shown in FIG. 13, the communications system 9 includes: a base station 91 and at least one first UE 92.

The base station 91 is configured to send a first reference signal to each first UE 92.

Any first UE 92 is configured to estimate first channel information of a first channel between the any first UE 92 and the base station 91 according to the first reference signal sent by the base station 91, and send the first channel information to the base station 91; and further configured to send a second reference signal to the base station 91.

The base station 91 is further configured to estimate second channel information of a second channel between the base station 91 and the any first UE 92 according to the received second reference signal, and perform reciprocity calibration according to the first channel information and the second channel information.

According to the communications system provided in this embodiment, a base station receives first channel information that is of a first channel between each first UE and a communication device and is estimated by each first UE according to a first reference signal sent by the base station, and second channel information that is of a second channel between each first UE and the communication device and is estimated according to a second reference signal reported by each first UE, so as to perform reciprocity error calibration between UEs according to the foregoing first channel information and the foregoing second channel information, thereby ensuring performance of the communications system.

An embodiment provides a communications system, and when the communications system is a second UE, as shown in FIG. 14, the communications system Sin includes: a second UE S101 and at least one first UE S102.

The second UE S101 is configured to send a first reference signal to each first UE S102.

Any first UE S102 is configured to estimate first channel information of a first channel between the any first UE S102 and the second UE S101 according to the first reference signal sent by the second UE S101, and send the first channel information to the second UE S101; and further configured to send a second reference signal to the second UE S101.

The second UE S101 is further configured to estimate second channel information of a second channel between the second UE S101 and the any first UE S102 according to the received second reference signal, and perform reciprocity calibration according to the first channel information and the second channel information.

According to the communications system provided in this embodiment, a second UE receives first channel information that is of a first channel between each first UE and the second UE and is estimated by each first UE according to a first reference signal sent by a base station, and second channel information that is of a second channel between each first UE and the second UE and is estimated according to a second reference signal reported by each first UE, so as to perform reciprocity error calibration between UEs according to the foregoing first channel information and the foregoing second channel information, thereby ensuring performance of the communications system.

It may be clearly understood by persons skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit partition is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The computer software product is stored in a storage medium and includes several instructions for instructing a computer device (which may be a personal computer, a server, or a network device) or a processor (processor) to perform all or some of the steps of the methods described in the embodiments of the present application. The foregoing storage medium includes: any medium that can store program code, such as a universal serial bus (USB) flash drive, a removable hard disk, a Read-Only Memory (ROM), a Random Access Memory (RAM), a magnetic disk, or an optical disc.

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. A method comprising:
sending, by a communication device to a first user equipment (UE), a first reference signal;
receiving, by the communication device fed back from the first UE, first channel information of a first channel between the first UE and the communication device according to the first reference signal;
receiving, by the communication device, a second reference signal sent by the first UE;
estimating second channel information of a second channel between the communication device and the first UE according to the second reference signal; and
performing reciprocity calibration according to the first channel information and the second channel information.

2. The method according to claim 1, wherein the communication device is a second UE and wherein the method further comprises:
sending, by the second UE to a base station, before sending the first reference signal, a first calibration request, so that the base station can send scheduling information to the second UE and to the first UE according to the first calibration request, wherein the scheduling information comprises an identifier of the first UE, an identifier of the second UE, and a time-frequency resource.

3. The method according to claim 1, wherein the communication device is a base station and wherein the method further comprises:
receiving, by the base station from the first UE, before sending the first reference signal, a second calibration request.

4. The method according to claim 3, further comprising sending, by the base station to the first UE, scheduling information according to the second calibration request, wherein the scheduling information comprises an identifier of the first UE and a time-frequency resource.

5. The method according to claim 1, wherein performing reciprocity calibration according to the first channel information and the second channel information comprises:
adjusting a reciprocity coefficient, wherein a first channel matrix corresponding to the first channel information is equal to a second channel matrix corresponding to the second channel information.

6. A method comprising:
receiving, by a first user equipment (UE) from a communication device, a first reference signal;
estimating, by the first UE, first channel information of a first channel between the first UE and the communication device according to the first reference signal;
sending, by the first UE to the communication device, the first channel information; and
sending, by the first UE to the communication device, a second reference signal, so that the communication device can estimate second channel information of a second channel between the communication device and the first UE according to the second reference signal and perform reciprocity calibration according to the first channel information and the second channel information.

7. The method according to claim 6, wherein the communication device is a second UE and wherein the method further comprises:
receiving, by the first UE, before receiving the first reference signal, scheduling information sent by a base station according to a first calibration request.

8. The method according to claim 6, wherein the communication device is a base station wherein the method further comprises:
sending, by the first UE to the base station, a second calibration request.

9. The method according to claim 8, further comprising receiving, by the first UE, before receiving the first reference signal, scheduling information sent by the base station according to the second calibration request, wherein the scheduling information comprises an identifier of the first UE and a time-frequency resource.

10. A communication device, comprising:
a processor; and
a non-transitory computer readable storage medium storing a program for execution by the processor, the program including instructions to:
send a first reference signal to a first user equipment (UE);
receive first channel information fed back by the first UE, the first channel information comprising information related to a first channel between the first UE and the communication device according to the first reference signal;
receive a second reference signal sent by the first UE;
estimate second channel information of a second channel between the communication device and the first UE according to the second reference signal; and
perform reciprocity calibration according to the first channel information and the second channel information.

11. The communication device according to claim 10, wherein the communication device is a second UE, wherein the instructions further comprise instructions to send a first calibration request to a base station, so that the base station can send scheduling information to the second UE and to the first UE according to the first calibration request, wherein the scheduling information comprises an identifier of the first UE, an identifier of the second UE, and a time-frequency resource.

12. The communication device according to claim 10, wherein the communication device is a base station and wherein the instructions further comprise instructions to receive a second calibration request sent by the first UE.

13. The communication device according to claim 10, wherein the instructions further comprise instructions to:
adjust a reciprocity coefficient, wherein a first channel matrix corresponding to the first channel information is equal to a second channel matrix corresponding to the second channel information.

14. A user equipment (UE), comprising:
a processor; and
a non-transitory computer readable storage medium storing a program for execution by the processor, the program including instructions to:
receive a first reference signal sent by a communication device, wherein first channel information of a first channel between the UE and the communication device is estimated according to the first reference signal;
send the first channel information to the communication device; and
send a second reference signal to the communication device, so that the communication device can estimate second channel information of a second channel between the communication device and the UE according to the second reference signal and perform reciprocity calibration according to the first channel information and the second channel information.

15. The UE according to claim 14, wherein the communication device is a second UE and wherein the instructions further comprise instructions to receive scheduling information sent by a base station according to a first calibration request, wherein the scheduling information comprises an identifier of the UE, an identifier of the second UE, and a time-frequency resource.

16. The UE according to claim 14, wherein the communication device is a base station, and wherein the instructions further comprise instructions to send a second calibration request to the base station, so that scheduling information can be sent by the base station according to the second calibration request, wherein the scheduling information comprises an identifier of the UE and a time-frequency resource.

17. A communications system comprising:
a communication device comprising:
a first processor; and
a first non-transitory computer readable storage medium storing a program for execution by the first processor, the program including instructions to:
send a first reference signal to a first user equipment (UE);
receive a first channel information fed back by the first UE;
receive a second reference signal sent by the first UE;
estimate second channel information of a second channel between the communication device and the first UE according to the second reference signal; and
perform reciprocity calibration according to the first channel information and the second channel information; and
the first UE comprising:
a second processor; and
a second non-transitory computer readable storage medium storing a program for execution by the second processor, the program including instructions to:
receive the first reference signal sent by the communication device;
estimate first channel information of a first channel between the first UE and the communication device according to the first reference signal;
send the first channel information to the communication device; and
send a second reference signal to the communication device.
